(19) United States
(12) Patent Application Publication
(10) Pub. No.: US 2008/0310516 A1
(43) Pub. Date: Dec. 18, 2008

(54) IMAGE PROCESSING APPARATUS AND METHOD

(76) Inventors: Hiroshi KOBAYASHI, Kanagawa (JP); Yoichi Hirota, Kanagawa (JP); Hiroaki Itou, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/137,997

(22) Filed: Jun. 12, 2008

(30) Foreign Application Priority Data
Jun. 14, 2007 (JP) P2007-157762

(51) Int. Cl. H04N 11/02

(52) U.S. Cl. 375/240.24; 375/E07.076

(57) ABSTRACT

An image processing apparatus includes: input means for inputting a video signal; decoding means for decoding the video signal; filtering means for performing predetermined filtering on the decoded video signal; and control means for calculating an average bit rate by dividing an amount of bits generated per predetermined data unit from the decoded video signal, and controlling a characteristic of the filtering in accordance with the average bit rate. When the video signal is input per image file, the control means calculates the average bit rate by dividing a file size of the image file by a playback time corresponding to the file size, and when the video signal input is sequentially input per picture, the control means calculates the average bit rate by dividing a sum of generated bits per picture for a predetermined number of frames by the predetermined number of frames and the frame rate.

### CROSS REFERENCES TO RELATED APPLICATIONS

The present invention contains subject matter related to Japanese Patent Application JP 2007-157762 filed in the Japanese Patent Office on Jun. 14, 2007, the entire contents of which are incorporated herein by reference.

### BACKGROUND OF THE INVENTION

1. Field of the Invention

The present invention relates to an image processing apparatus and method for performing filter processing on a video signal input by a predetermined input means.

2. Description of the Related Art

In recent years, for an encoding method of a video signal, in addition to MPEG (Moving Picture Expert Group) 2, which has been widely used to date, the other encoding methods, such as MPEG-AVC/H.264 (in the following, called AVC) has come to be used.

Also, display apparatuses, such as a television receiver, etc., have been increasingly used not only for displaying moving pictures, but also for displaying still images encoded by JPEG (Joint Photographic Experts Group), etc.

Also, in such display apparatuses, video contents created by games and computer graphics have been increasingly used in the same viewing environments as those of a recording medium, such as a DVD, etc.

In order to display a video signal which is input from the outside with higher image quality, display apparatuses incorporate an image processor that performs filter processing, for example such as a noise-reduction filter for reducing block noise, etc., included in the video signal, and an edge enhancement filter for enhancing edges of images.

In such an image processing apparatus, the characteristics of a noise elimination filter, an edge enhancement filter, etc., are controlled using quantization information, which can be used for the same index as a compression rate of an encoded video signal, as a control index for determining the characteristics of the filters (refer to Japanese Unexamined Patent Application Publication No. 2003-18600).

### SUMMARY OF THE INVENTION

In a related-art image processing apparatus, when filter processing is performed on a video signal stored on a storage medium, such as a DVD, etc., it is possible to calculate an average bit rate from an already-known image-file size and a playback time of the video image, and to control the characteristic of a filter in accordance with the average bit rate. However, for example, when the sequence of a video to be played back from a ROM content, etc., is not uniquely determined, specifically, when the sequence of a video to be played back is selected by an operation instruction by a user, or is programmed, it has not been possible to obtain an average bit rate in advance. Also, when a video signal for each picture, such as streaming, is transmitted from a broadcast wave, it is not possible to calculate an average bit rate by the above-described method. Thus, it has not been possible to appropriately control the characteristic of a filter.

The present invention has been proposed in view of these circumstances. It is desirable to provide an image processing apparatus and method which calculates the average bit rate of a video signal with high precision in accordance with the attribute of the input video signal, and controls the characteristic of filter processing on the video signal in accordance with the calculated bit rate.

According to an embodiment of the present invention, there is provided an image processing apparatus including: input means for inputting a video signal; decoding means for decoding the video signal input by the input means; filtering means for performing predetermined filter processing on the video signal decoded by the decoding means; and control means for calculating an average bit rate by dividing an amount of bits generated per predetermined data unit from the video signal decoded by the decoding means, and controlling a characteristic of filter processing performed by the filtering means in accordance with the average bit rate, wherein when the video signal input by the input means is input per image file, the control means calculates the average bit rate by dividing a file size of the image file by a playback time corresponding to the file size, and when the video signal input by the input means is sequentially input per picture, the control means calculates the average bit rate by dividing a sum of generated bits per picture for a predetermined number of frames by the predetermined number of frames and the frame rate.

Also, according to another embodiment of the present invention, there is provided a method of performing image processing on a video signal input by predetermined input means, the method including the steps of: decoding the video signal input by the input means; filtering for performing predetermined filter processing on the video signal decoded by the step of decoding; and controlling for calculating an average bit rate by dividing an amount of bits generated per predetermined data unit from the video signal decoded by the step of decoding, and controlling a characteristic of the filter processing in accordance with the average bit rate, wherein, in the step of controlling, when the video signal input by the input means is input per image file, the average bit rate is calculated by dividing a file size of the image file by a playback time corresponding to the file size, and when the video signal input by the input means is sequentially input per picture, the control means calculates the average bit rate by dividing a sum of generated bits per picture for a predetermined number of frames by the predetermined number of frames and the frame rate.

In the present invention, when a video signal is input by the input means per image file, the average bit rate is calculated by dividing a file size of the image file by a playback time corresponding to the file size, and when a video signal is sequentially input by the input means per picture, the average bit rate is calculated by dividing a sum of generated bits per picture for a predetermined number of frames by the predetermined number of frames and the frame rate. It is therefore possible to calculate the average bit rate of a video signal with high precision in accordance with the attribute of an input video signal, and further to control the characteristic of filter processing on the video signal in accordance with the calculated bit rate. Accordingly, it is possible to perform best-suited filter processing in accordance with the characteristic of the video signal.

### BRIEF DESCRIPTION OF THE DRAWINGS

FIG. 1 is a block diagram illustrating an overall configuration of an optical-disc playback and recording apparatus;

FIG. 2 is a schematic diagram illustrating a connection relationship between an optical-disc playback and recording apparatus and a receiver;

FIG. 3 is a diagram illustrating a specific configuration of a video graphics processor;

FIG. 4 is a diagram illustrating a specific configuration of an enhancer;

FIG. 5 is a graph illustrating an input/output characteristic of a limiter;

FIG. 6 is a graph illustrating an input/output characteristic of a gain adjuster;

FIG. 7 is a graph illustrating a change of an average bit rate with time as a control index;

FIG. 8 is a diagram illustrating a weighting factor in accordance with an encoding method of a video signal;

FIG. 9 is a diagram illustrating a weighting factor in accordance with an image-frame size of a video signal;

FIG. 10 is a graph illustrating a change of an average bit rate with time as a control index;

FIG. 11 is a graph illustrating a change of an average bit rate with time as a control index;

FIG. 12 is a graph illustrating a change of a characteristic of Gain_BR versus Ave_BR;

FIG. 13 is a diagram illustrating a weighting factor in accordance with a corresponding relationship between an input-image-frame size of a video signal and an output-image-frame size;

FIG. 14 is a diagram illustrating a weighting factor in accordance with an encoding method of a video signal;

FIG. 15 is a diagram illustrating a weighting factor in accordance with a deblocking filter parameter;

FIG. 16 is a diagram illustrating a weighting factor in accordance with a type of medium of an input video signal;

FIG. 17 is a diagram illustrating a weighting factor in accordance with a type of medium of an input video signal;

FIG. 18 is a diagram illustrating a weighting factor in accordance with a type of medium of an input video signal;

FIG. 19 is a diagram illustrating a weighting factor in accordance with a type of medium of an input video signal; and

FIG. 20 is a diagram illustrating a weighting factor in accordance with a type of medium of an input video signal.

### DESCRIPTION OF THE PREFERRED EMBODIMENTS

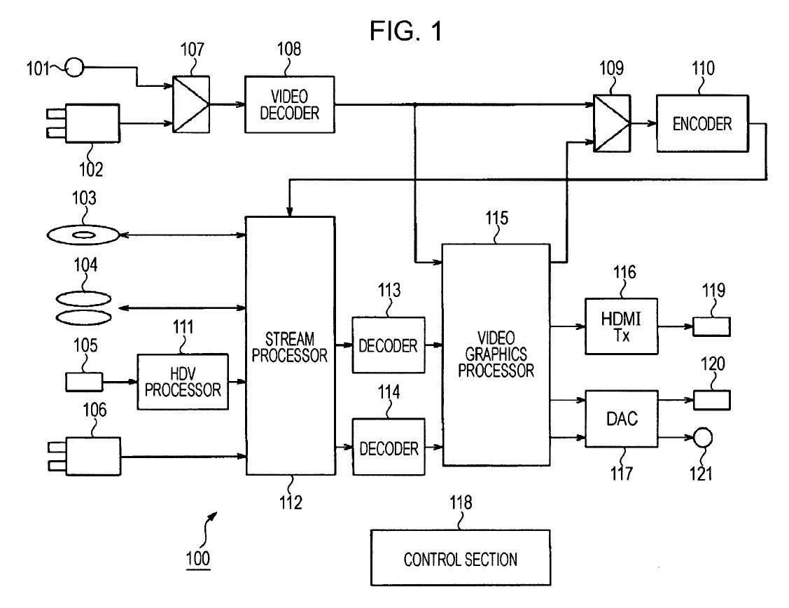

In an image processing apparatus to which the present invention is applied, filter processing is performed on a video signal which has been input by predetermined input means. In the following, as a preferred embodiment, a detailed description will be given of an optical-disc recording and playback apparatus 100, shown in FIG. 1, including the above-described image processing apparatus.

The optical-disc recording and playback apparatus 100 reads a video signal stored, for example on a DVD, etc., performs predetermined image processing on the read video signal, and outputs the video signal onto a display apparatus, such as a liquid crystal display, etc.

Specifically, the optical-disc recording and playback apparatus 100 includes a line-input terminal 101 for inputting an analog video signal from the outside as input means of the video signal, an analog tuner 102 for receiving an analog broadcast wave and demodulating the wave to an analog video signal, an optical disc drive 103 for reading a video signal from a storage medium, such as a DVD, etc., a hard disk drive 104 in which a video signal is stored, an HDV input terminal 105 for inputting a video signal of the HDV (High-Definition Video) standard, and a digital tuner 106 for receiving a digital broadcast wave and demodulating the wave to a digital video signal.

Also, the optical-disc recording and playback apparatus 100 includes, as means for performing predetermined signal processing on a video signal, a selector 107 which is electrically connected to the line-input terminal 101 and the analog tuner 102 individually, a video decoder 108 which decodes the analog video signal to a baseband video signal, a selector 109 which is electrically connected to the video decoder 108 and a video graphics processor 115 described below individually, an encoder 110 which encodes the baseband video signal into a predetermined encoding format, an HDV processor 111 which performs predetermined processing on the digital video signal input into the HDV input terminal 105, a stream processor 112 which performs predetermined processing on the encoded video signal, two decoders 113 and 114 which decode the video signal output from the stream processor 112 into a baseband video signal, the video graphics processor 115 which performs video signal processing described below on the baseband video signal, an HDMI (High-Definition Multimedia Interface) transmitter 116 which converts the baseband video signal into an TMDS (Transition Minimized Differential Signaling) signal, and a DAC 117 which converts the baseband video signal into an analog-component video signal and analog-composite video signal.

Furthermore, the optical-disc recording and playback apparatus 100 includes, as means for outputting a video signal to a display apparatus, etc., an HDMI connector 119 for outputting the TMDS signal converted by the HDMI transmitter 116 to the outside, a component-output terminal 120 for outputting the analog-component-video signal converted by the DAC 117 to the outside, and a composite output terminal 121 for outputting the analog-composite-video signal converted by the DAC 117 to the outside.

In the optical-disc recording and playback apparatus 100 having the above configuration, the operation of each processing section described above is controlled by a control section 118 including a main CPU.

The line-input terminal 101 receives the input of an analog video signal from the outside, and supplies the input analog video signal to the video decoder 108 through the selector 107.

The analog tuner 102 receives an analog broadcast wave, demodulates the wave into an analog video signal, and supplies the demodulated analog video signal to the video decoder 108 through the selector 107.

The optical disc drive 103 reads the video signal recorded on a recording medium, for example, such as a DVD, a BD (Blu-ray Disc) which is a high-density recording disc using blue-violet laser light, an HDDVD (High-Definition Digital Versatile Disc), etc., and supplies the read video signal to the stream processor 112.

The hard disk drive 104 stores the encoded video signal, reads the video signal to supply the signal to the stream processor 112.

The HDV input terminal 105 receives the input of a video signal of the HDV standard from the outside, and supplies the input video signal to the HDV processor 111.

The digital tuner 106 receives a digital broadcast wave, demodulates the wave into a digital video signal, and supplies the demodulated digital video signal to the stream processor 112.

The selector 107 selects one of the analog video signals supplied individually from the line-input terminal 101 and the analog tuner 102, and supplies the signal to the video decoder 108.

The video decoder 108 converts the analog video signal supplied from the selector 107 into a digital video signal, separates the signal into a luminance signal and a color-difference signal, and performs decode processing to convert the signals into a baseband video signal. The video decoder 108 supplies the baseband video signal individually to the selector 109 and the video graphics processor 115.

The selector 109 selects one of the baseband video signals output from the video decoder 108 and the video graphics processor 115, and supplies the signal to the encoder 110.

The encoder 110 encodes the baseband video signal supplied through the selector 109 by a desired encoding system, for example, MPEG1, MPEG2, MPEG4, AVC, etc., and supplies the encoded digital video signal to the stream processor 112.

The HDV processor 111 receives the input signal conforming to the IEEE 1394 standard, which was supplied from the HDV input terminal 105, and supplies the TS (Transport Stream) of the supplied signal to the stream processor 112 as a digital video signal.

The stream processor 112 supplies the digital video signal supplied from the encoder 110 to the optical disc drive 103 and the hard disk drive 104 for storage. Also, the stream processor 112 supplies the digital video signal supplied from the digital tuner 106, etc., to the decoders 113 and 114.

The decoders 113 and 114 are provided in parallel, individually perform decode processing on the digital video signals supplied from the stream processor 112, and supply the baseband video signals having been subjected to decode processing to the video graphics processor 115. In this regard, if a single video signal is input, and the input video signal is decoded, only one of the decoders 113 and 114 may be used.

The video graphics processor 115 performs video signal processing, such as image-frame-size conversion processing as described below on the supplied baseband video signals, and supplies the signals to the selector 109, the HDMI transmitter 116, and the DAC 117.

The HDMI transmitter 116 converts the baseband video signal supplied from the video graphics processor 115 into a TMDS signal, and outputs the signal from the HDMI connector 119 to the outside. In this regard, the HDMI connector 119 outputs a control signal, supplied from the control section 118, for performing communication with an external device to the outside.

The DAC 117 performs D/A conversion on the baseband signals supplied from the video graphics processor 115, and outputs the analog-component video signal and the analog-composite video signal from the component-output terminal 120 and the composite-output terminal 121, to the outside respectively.

The optical-disc recording and playback apparatus 100 having the above configuration performs communication with a receiver displaying a video signal in the following manner, and thus supplies the video signal.

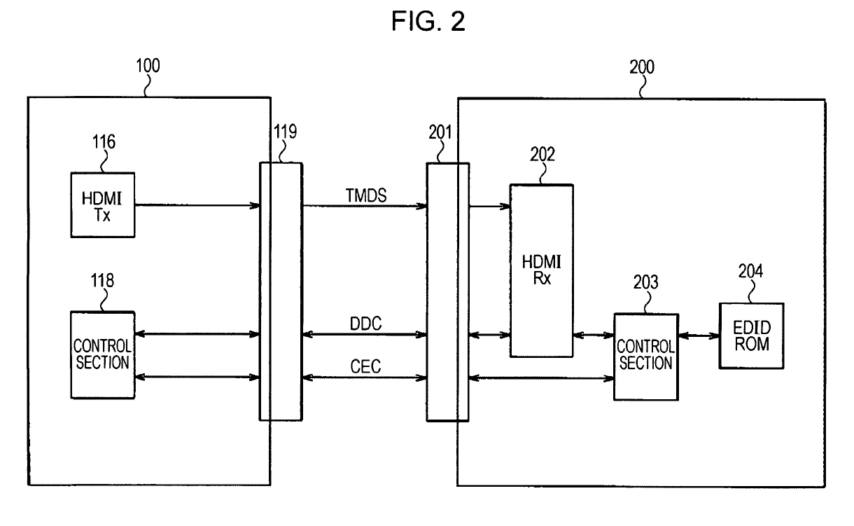

As shown in FIG. 2, in the optical-disc recording and playback apparatus 100, the HDMI transmitter 116 outputs the TMDS signal to the receiver 200 through the HDMI connector 119, and the control section 118 performs communication with the receiver 200 through the HDMI connector 119.

Specifically, the control section 118 outputs a DDC (Display Data Channel) signal for obtaining an output resolution information of the receiver 200 and a CEC (Consumer Electronics Control) signal for performing a bi-directional communication with the receiver 200 to the receiver 200 through the HDMI connector 119.

On the other hand, the receiver 200 includes an HDMI connector 201 for inputting the TMDS signal, the DDC signal, and the CEC signal, which are output from the optical-disc recording and playback apparatus 100, an HDMI receiver 202 for converting the TMDS signal input by the HDMI connector 201 into a baseband video signal, a control section 203 for controlling the operation of the entire receiver 200, and an EDID (Extended Display Identification Data) ROM 204 connected to the control section 203.

The HDMI connector 201 receives the input of the TMDS signal, the DDC signal, and the CEC signal, which are output from the optical-disc recording and playback apparatus 100, and supplies the input TMDS signal and the DDC signal to the HDMI receiver 202.

The HDMI receiver 202 separates the TMDS signal input from the HDMI connector 201 into a baseband video signal, an audio signal, and a control signal, and supplies the control signal to the control section 203. Also, the HDMI receiver 202 supplies the DDC signal input from the HDMI connector 201 to the control section 203.

The control section 203 reads display information from the EDIDROM 204 storing the resolution information corresponding to the receiver 200 on the basis of the DDC information supplied from the HDMI receiver 202. Next, the control section 203 outputs the read display information to the optical-disc recording and playback apparatus 100 through the HDMI receiver 202 and the HDMI connector 201.

Next, a description will be given of specific processing of the video graphics processor 115.

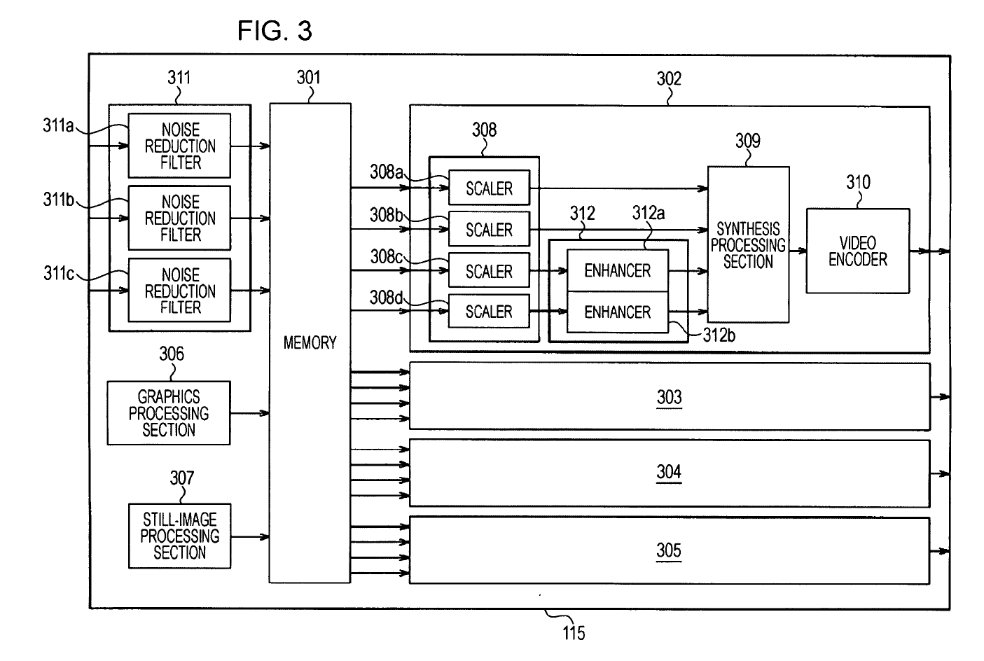

As shown in FIG. 3, the video graphics processor 115 includes a memory 301 for temporarily storing a video signal, a plurality of image-processing circuit groups 302, 303, 304, and 305 for reading the video signals stored in the memory 301 and performing image processing on the signals, a graphics processing section 306 for performing data processing on graphics data, and a still-image processing section 307 for performing image processing on a still image, such as JPEG data, etc.

The image-processing circuit group 302 includes an image-frame-size conversion section 308 for converting the image-frame size of the video signal, an edge enhancement filter 312 for enhancing edges of an image on the video signal, a synthesis processing section 309 for synthesizing images, and a video encoder 310 for outputting the video signal as a baseband video signal in synchronism with the other processing sections. In this regard, the image-processing circuit groups 303, 304, and 305 have the same configuration as that of the image-processing circuit group 302.

Also, the video graphics processor 115 includes three noise reduction filters 311a, 311b, and 311c which reduce noise components included in the video signals supplied from the other processing sections. The individual noise reduction filters 311a, 311b, and 311c perform processing for reducing block noises, frame noises, and mosquito noises as described below on the baseband video signals input from the video decoder 108, and the decoders 113 and 114, respectively, and supplies the signals to the memory 301. Specific processing contents of the three noise reduction filters 311a, 311b, and 311c are the same, and thus a description will be given using a noise reduction filter 311 as a generic name for the sake of convenience.

The memory 301 temporarily stores the baseband video signal supplied from the video decoder 108, and the decoders 113 and 114 through the noise reduction filter 311 into a predetermined video-image storage area. Also, the memory 301 stores the graphics data supplied from the graphics processing section 306 into a graphics storage area, and stores still-image data supplied from the still-image processing section 307 into a still-image storage area. Next, the memory 301 supplies the data stored in individual memory areas to the image-processing circuit groups 302, 303, 304, and 305, respectively.

The image-processing circuit group 302 reads the data, such as the baseband video signal, etc., stored in the memory 301, and supplies the read video signal to the image-frame-size conversion section 308.

The image-frame-size conversion section 308 has four scalers 308a, 309b, 308c, and 308d for converting an image-frame size in accordance with a control instruction from the control section 118. Specifically, the image-frame-size conversion section 308 reads four different video signals from the memory 301, and performs conversion processing of the image-frame size simultaneously in parallel. Next, the scalers 308a and 309b supply the video signal having been subjected to the image-frame-size conversion to the synthesis processing section 309. Also, the scalers 308c and 309d supply the video signal having been subjected to the image-frame-size conversion to the edge enhancement filter 312.

The edge enhancement filter 312 performs filter processing enhancing the edges of an image on the video signal having been subjected to the image-frame-size conversion by the image-frame-size conversion section 308. The edge enhancement filter 312 includes enhancers 312a and 312b for performing edge enhancement on, for example the video signals supplied from the scalers 308c and 309d simultaneously in parallel. The edge enhancement filter 312 individually supplies the video signals having been subjected to the edge enhancement processing by the enhancers 312a and 312b to the synthesis processing section 309.

The synthesis processing section 309 combines the two video signals simultaneously supplied from the image-frame-size conversion section 308 and the two video signals simultaneously supplied from the edge enhancement filter 312, and supplies the combined video signal to the video encoder 310.

The video encoder 310 adds a synchronization signal to the video signal supplied from the synthesis processing section 309, converts the video signal into a baseband video signal or composite video signal having a desired specification, and outputs the signals to the other processing section.

In the optical-disc recording and playback apparatus 100 having the above-described configuration, the video graphics processor 115 adaptively controls the characteristics of the noise-reduction filter processing and the edge-enhancement filter processing in accordance with the attribute of each video signal input by the above-described input means to output the video signal having high image quality to the receiver 200, etc.

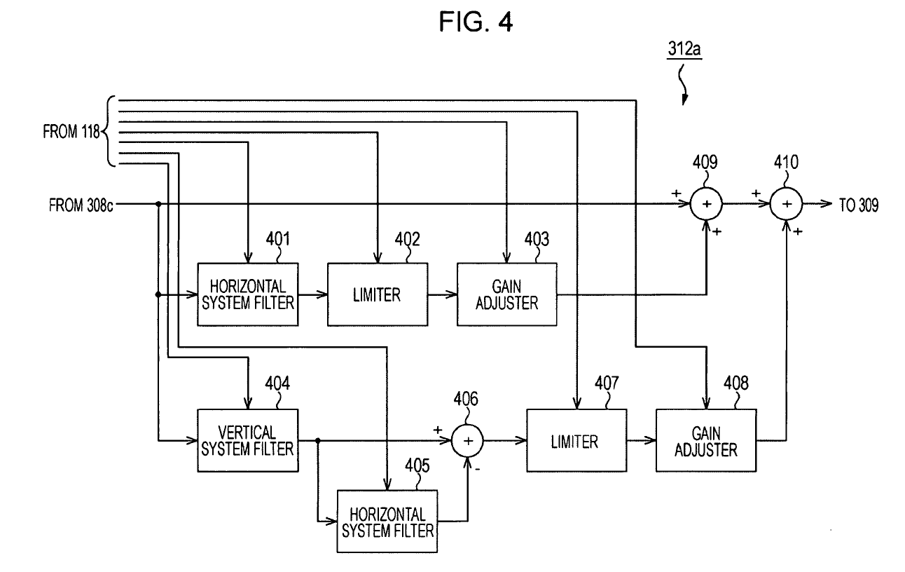

Next, a description will be given of the edge-enhancement filter processing with reference to FIG. 4. FIG. 4 is a block diagram illustrating a specific configuration of the enhancers 312a and 312b of the edge enhancement filter 312. In this regard, the enhancers 312a and 312b have the same configuration, and thus a description will be given of the enhancer 312a as a representative of them.

The enhancer 312a includes, as means for enhancing horizontal components of edges of an image, a horizontal system filter 401 for extracting high-frequency components in the horizontal direction from a video signal, a limiter 402 for limiting amplitude components on the video signal, and a gain adjuster 403 for adjusting the gain of the video signal. Also, the enhancer 312a includes, as means for enhancing vertical components of edges of an image, a vertical system filter 404 for extracting high-frequency components in the vertical direction from the video signal, a horizontal system filter 405 for extracting high-frequency components in the horizontal direction from the video signal, a subtracter 406 for subtracting the signal output from the horizontal system filter 405 from the signal output from the vertical system filter 404, a limiter 407 for limiting amplitude components on the signal output from the limiter 407, and a gain adjuster 408 for adjusting the gain of the signal output from the limiter 407. Furthermore, the enhancer 312a includes an adder 409 for adding the signal output from the gain adjuster 403 to the video signal read from the memory 301, and an adder 410 for adding the signal output from the gain adjuster 408 to the video signal having been subjected to the addition processing by the adder 409.

The horizontal system filter 401 receives the input of the video signal read from the memory 301, extracts high-frequency components of the video signal in the horizontal direction, and supplies them to the limiter 402.

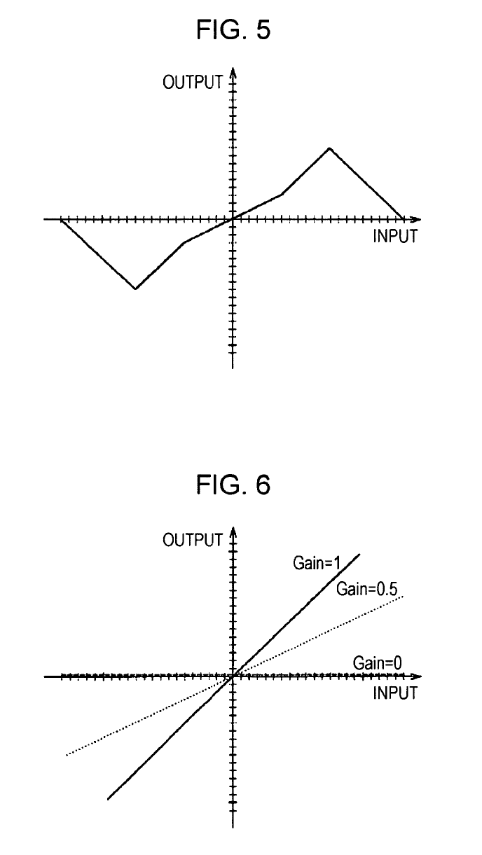

The limiter 402 puts a limit of the amplitude component, as shown in FIG. 5, on the video signal extracted from the horizontal system filter 401. In FIG. 5, the horizontal axis shows an amplitude value of the input video signal, and the vertical axis shows an amplitude value of the video signal output from the limiter 402. That is to say, the limiter 402 supplies the video signals whose amplitude components being limited for the sake of not enhancing the noise of small amplitude components and of large amplitude components to the gain adjuster 403.

The gain adjuster 403 adjusts the gain of the video signal supplied from the limiter 402 as shown in FIG. 6, and supplies the signal to the adder 409. In FIG. 6, the horizontal axis shows an amplitude value of the video signal supplied from the limiter 402, and the vertical axis shows an amplitude value of the output video signal.

The vertical system filter 404 receives the input of the video signal read from the memory 301, extracts high-frequency components of the video signal in the vertical direction, and supplies them individually to the horizontal system filter 405 and the subtracter 406.

The horizontal system filter 405 extracts high-frequency components of the video signal in the horizontal direction on the video signal supplied from the vertical system filter 404, and supplies them to the subtracter 406. In this regard, the horizontal system filter 405 is designed to have the same frequency characteristic as that of the horizontal system filter 401.

The subtracter 406 subtracts the video signal output from the horizontal system filter 405 from the video signal output from the vertical system filter 404, and supplies the signal to the limiter 407. In this manner, the enhancer 312a works on the video signal read from the memory 301 so as not to enhance a slanting component, on which the horizontal component and the vertical component overlap, by the processing related to the subtracter 406.

The limiter 407 puts a limit of the amplitude, as shown in FIG. 5, on the video signal output from the horizontal system filter 406, and supplies the signal to the gain adjuster 408.

The gain adjuster 408 adjusts the gain of the video signal supplied from the limiter 407 as shown in FIG. 6 described above, and supplies the signal to the adder 410.

In the enhancer 312a having the above configuration, the characteristics of the horizontal system filters 401 and 405, and the vertical system filter 404 are controlled in accordance with a control instruction supplied from the control section 118. Also, in the enhancer 312a, the characteristics of the limiters 402 and 407, and the gain adjusters 403 and 408 are controlled in accordance with a control instruction supplied from the control section 118. That is to say, the operation characteristics of the enhancers 312a 312b are controlled by the control section 118.

In this regard, for the edge enhancement filter 312, the enhancer 312a is not limited to have the above-described configuration, and the edge enhancement processing using the other methods may be used.

Next, the control section 118 obtains a control index for appropriately controlling the operation characteristic of the edge enhancement filter 312 as follows.

First, the control section 118 calculates an average bit rate by dividing the amount of generated bits per unit data of the video signal in an encoded state by the playback time of the video corresponding to the unit data as a first control index.

The control section 118 identifies the attribute of the video signal from which an average bit rate is calculated. Among video signals, the video signals read from the above-described optical disc drive 103 and the hard disk drive 104 include the file size (the amount of generated bits) GB_File for each title of content and the playback time T_File of the video of this time. Accordingly, when the control section 118 reads the video signal from the optical disc drive 103 and the hard disk drive 104, the control section 118 calculates an average bit rate BR_File by the following expression (1).

[Expression 1]

BR_File [bit/sec]=GB_File [bit]/T_File [sec] (1)

That is to say, the control section 118 calculates the average bit rate BR_File of the video signal stored on a recording medium by the expression (1). However, for the video signal being supplied in real time, such as a video signal for each picture like a broadcast wave, the control section 118 calculates an average bit rate BR_Stream per n frames (n is a natural number) for each n frames in sequence by the following expression (2).

$$\begin{matrix}[ Expression 2 ] & \\ BR\_Stream [ bit / sec ] = {\sum }_{1}^{n} ( GB\_Stream [ bit ] ) / ( n [ Frame ] / FR [ Frame / sec ] ) & ( 2 )\end{matrix}$$

Here, the amount of generated bits Σ (GB_Stream) is a value produced by integrating the amount of generated bits per picture for n frames. Also, the frame rate FR is the number of frames for each unit time.

In this regard, even for the video signal stored on a recording medium, when the playback processing is not uniquely determined, the control section 118 calculates the average bit rate by the expression (2).

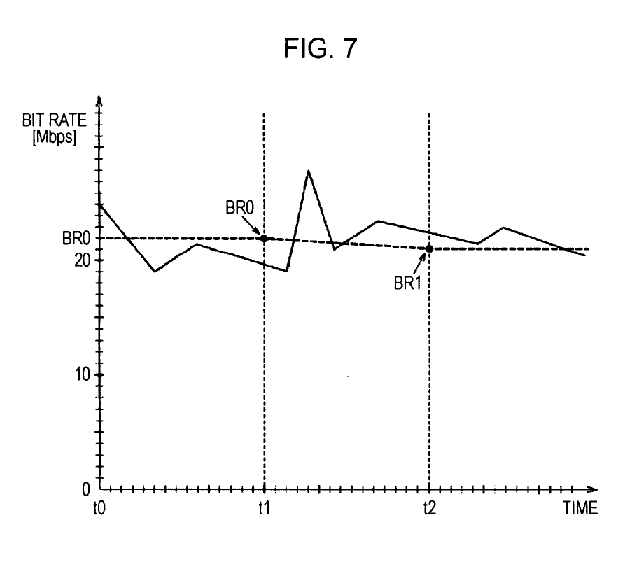

The control section 118 controls the characteristic of the edge enhancement filter 312 as shown in FIG. 7 using the calculated average bit rate as a control index.

If the control section 118 frequently changes the strength of edge enhancement performed on the video signal, the image quality is deteriorated, and thus, for example, the control section 118 calculates the average bit rate from the amount of generated bits for the number of frames for each one minute.

Specifically, when a video signal of 1920×1080×60 i is input, the control section 118 first sets a reference bit rate BR_ref to 22 [Mbps] as shown in FIG. 7. Next, the control section 118 controls the characteristic of the edge enhancement filter 312 so as to set an initial value BR0 of the average bit rate during one minute from time t0 to t1 to RB_ref.

The control section 118 calculates the average bit rate of the video signal to be processed by the following expression (3) during the video playback time from time t0 to t1, and assumes this to be BR1.

$$\begin{matrix}[ Expression 3 ] & \\ BR 1 = {\sum }_{t 0}^{t 1} ( BR\_Stream ) / ( t 1 - t 0 ) & ( 3 )\end{matrix}$$

The control section 118 determines the calculated BR1 to be a control index for controlling the characteristic of the processing performed by the edge enhancement filter 312 at time t2 and after that. Accordingly, as shown in FIG. 7, the control section 118 controls the characteristic of the edge enhancement filter 312 using the linearly interpolated values between BR0 and BR1 as a control index related to the playback time of the video from time t1 to time t2. In this regard, in FIG. 7, a solid line shows the fluctuation values of the actual bit rate of the video signal, and a broken line shows the average bit rate to be used for a control index produced by the linear interpolation as described above.

As described above, when a video signal is stored in advance on a predetermined storage medium, such as a DVD, etc., as an image file including an encoded video signal, the control section 118 calculates the average bit rate by dividing the size of the image file by the playback time of the video. When a video signal is sequentially input per picture from the digital tuner 106, etc., the average bit rate is calculated by dividing the sum of generated bits per picture for a predetermined number of frames by the predetermined number of frames and the frame rate. It is therefore possible to calculate the average bit rate of a video signal with high precision in accordance with the attribute of an input video signal, and further to control the characteristic of the filter processing on the video signal in accordance with the calculated bit rate. Accordingly, it is possible to perform best-suited filter processing on the video signal.

Also, the control section 118 determines the average bit rate calculated as described above to be a first video-signal attribute, further performs weighting processing on the average bit rate in accordance with the following video-signal attribute, and controls the characteristic of the filter using the average bit rate having been subjected to the weighting processing as a control index.

First, the control section 118 determines a second video-signal attribute to be an encoding method, and performs weighting on the average bit rate in accordance with the encoding method. Specifically, the control section 118 represents a weighting factor to be W_Rate_Codec in accordance with an encoding method, and sets W_Rate_Codec low in order of an encoding method having a low compression efficiency. The reason of setting in this manner is that if video signals have the same bit rate, the higher the compression efficiency of an encoding method of a video signal, the higher the image quality is obtained. As shown in FIG. 8, the control section 118, for example sets the value of W_Rate_Codec to 1, which is a reference value when the encoding method is MPEG2. The control section 118 sets the value of W_Rate_Codec to 1.6 when the encoding method is VC−1, and W_Rate_Codec to 1.8 when the encoding method is AVC. In this manner, the control section 118 controls the characteristic of the edge enhancement filter 312 in accordance with the encoding method of the video signal in addition to the average bit rate.

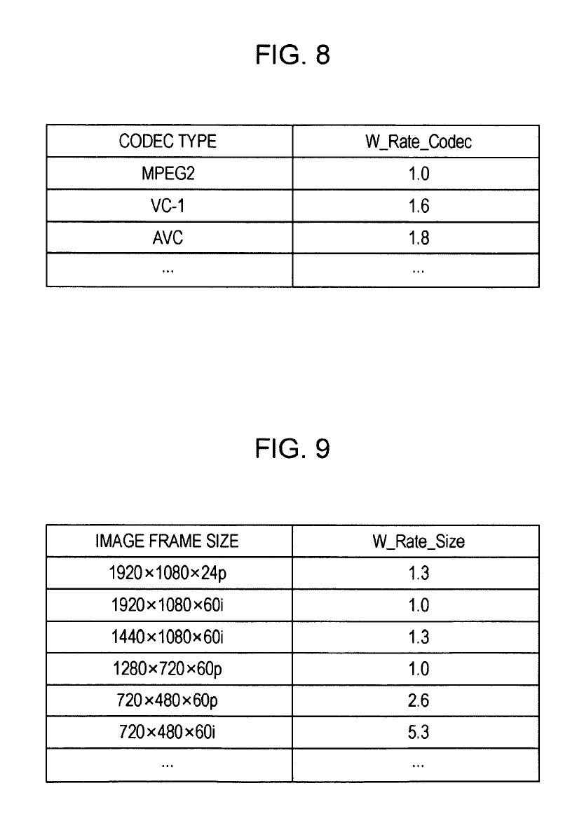

Also, the control section 118 performs weighting on the average bit rate in accordance with the image-frame size by determining a third video-signal attribute to be an image-frame size. Specifically, the control section 118 represents a weighting factor according to the image-frame size to be W_Rate_Size. As shown in FIG. 9, the control section 118 sets W_Rate_Size low in order of the image-frame size being smaller. The reason of setting in this manner is that if video signals have the same bit rate, the smaller the image-frame size, the higher the image quality is obtained. In this manner, the control section 118 controls the characteristic of the edge enhancement filter 312 in accordance with the image-frame size of the video signal in addition to the average bit rate.

As described above, the control section 118 calculates a control index by an encoding method of the video signal and an image-frame size in addition to the average bit rate. As shown in FIG. 10, the control section 118 controls the characteristic of the edge enhancement filter 312 in accordance with the calculated control index.

Specifically, during the playback time of the image from time t0 to time t1, the control section 118 calculates the average bit rate BR1 as a control index for controlling the characteristic of the edge enhancement filter 312 which performs processing at time t2 and after that by the following expression (4).

$$\begin{matrix}[ Expression 4 ] & \\ BR 1 = W\_Rate \_Codec \times W\_Rate \_Size \times {\sum }_{t 0}^{t 1} ( BR\_Stream ) / ( t 1 - t 0 ) & ( 4 )\end{matrix}$$

For example, when the codec type is AVC, and the image-frame size 1440×1080×60 i, the control section 118 calculates BR1 by the following expression (5).

$$\begin{matrix}[ Expression 5 ] & \\ BR 1 = 1.8 \times 1.3 \times {\sum }_{t 0}^{t 1} ( BR\_Stream ) / ( t 1 - t 0 ) & ( 5 )\end{matrix}$$

The control section 118 determines the calculated BR1 to be a control index for controlling the characteristic of the processing performed by the edge enhancement filter 312 at time t2 and after that. Accordingly, as shown in FIG. 10, the control section 118 controls the characteristic of the edge enhancement filter 312 using the linearly interpolated values between BR0 and BR1 as a control index related to the playback time of the video from time t1 to time t2. In this regard, in FIG. 10, a solid line shows the fluctuation values of the actual bit rate of the video signal, and a broken line shows the average bit rate as a control index having been subjected to the weighting processing as described above.

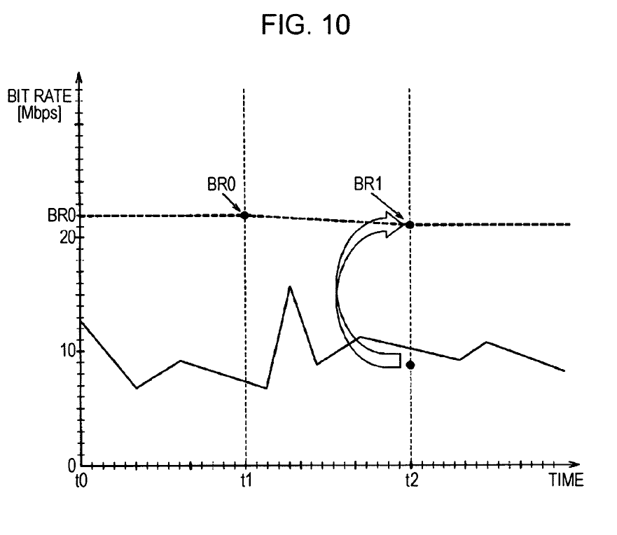

Also, as shown in FIG. 11, the control section 118 may not determine the control parameter at time t2 and after that to be constant, and may calculate the average bit rate having been weighted in sequence to use the linear interpolated values of the calculation result as the control index.

The control section 118 calculates, for example, the average bit rate BR2 as a control index related to the video playback time from time t1 to time t2 by the following expression (6).

$$\begin{matrix}[ Expression 6 ] & \\ BR 2 = W\_Rate \_Codec \times W\_Rate \_Size \times {\sum }_{t 1}^{t 2} ( BR\_Stream ) / ( t 2 - t 1 ) & ( 6 )\end{matrix}$$

After this, in the same manner, the control section 118 calculates the average bit rate BRX as a control index concerning an arbitrary video playback time.

Furthermore, when the control section 118 calculates the average bit rate of the video signal stored on a recording medium in advance, the control section 118 my control the characteristic of the edge enhancement filter 312 in accordance with a weighted average of the average bit rates Ave_BR as shown by the following expression (7), which is produced from the sum of BR_File and a sequential average bit rate BRX obtained by the expression (1).

[Expression 7]

Ave_{—}BR=(BR_File+BRX)/2 (7)

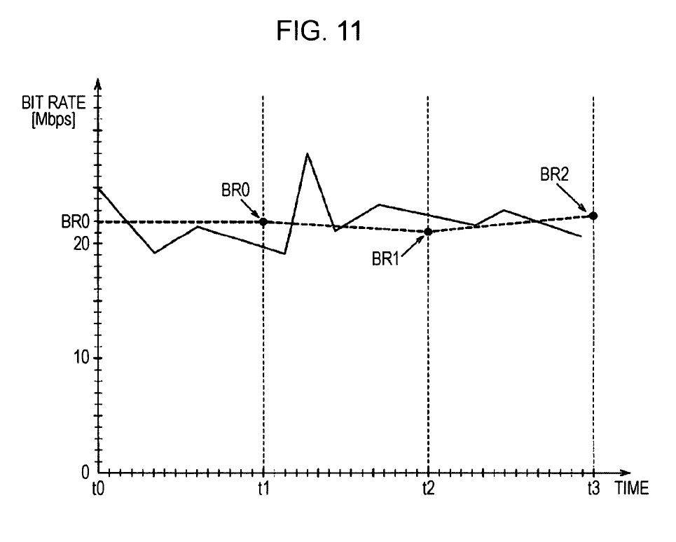

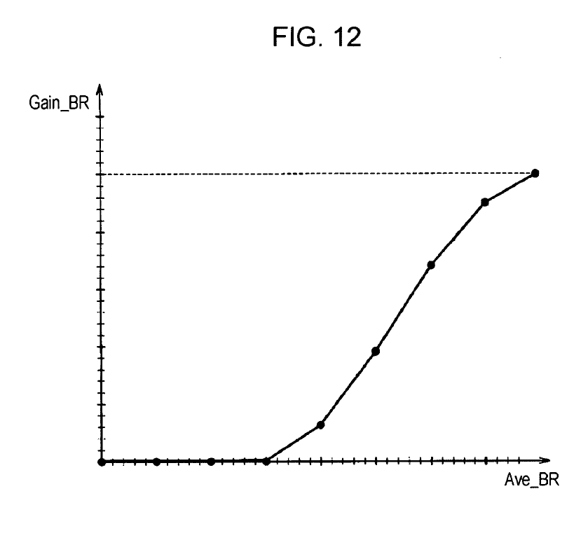

In this regard, when the control section 118 sets a control parameter Gain_BR related to the gain characteristic of the enhancer 312a from Ave_BR calculated by the expression (7), the control section 118 may have a nonlinear characteristic between Ave_BR and Gain_BR, for example as shown in FIG. 12.

Also, the control section 118 may control the characteristic of the edge enhancement filter 312 using the average bit rate weighted in accordance with the encoding method and the image-frame size by the following expression (8) in contrast to the average bit rate BR_File obtained by the expression (1).

[Expression 8]

W_{—}BR_File=W_Rate_Codec×W_Rate_Size×B_File (8)

Also, the control section 118 may control the characteristic of the edge enhancement filter 312 in accordance with the following video-signal attribute other than an average bit rate, an encoding method, and an image-frame size as described above. Specifically, the control section 118 controls the characteristic of the edge enhancement filter 312 using the amount of blurring to be added to the input video signal as a control index.

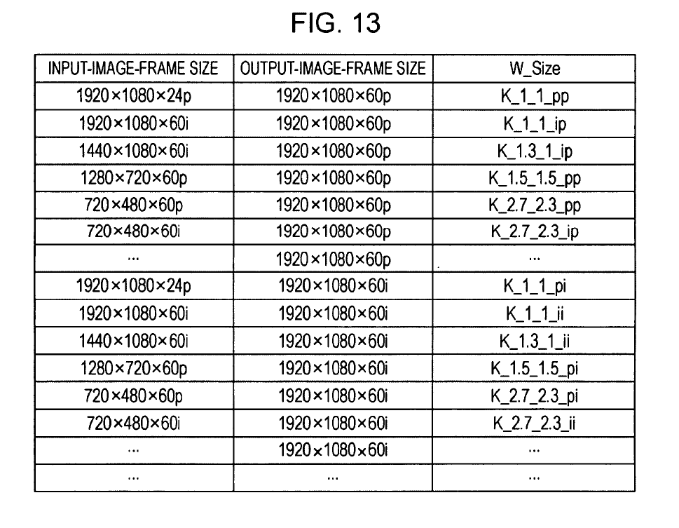

That is to say, as a third video-signal attribute, the control section 118 controls the characteristic of the edge enhancement filter 312 in accordance with a corresponding relationship of the image-frame sizes between the video signal converted by the image-frame-size conversion section 308 and the video signal before the conversion. Specifically, the control section 118 sets a weighting factor W_Size for each relationship by setting a plurality of corresponding relationships, as shown in FIG. 13, between input-image-frame sizes and output-image-frame sizes.

Here, the weighting factor W_Size shown in FIG. 13 does not define simply one control parameter, but also defines values of a plurality of kinds of control parameters. That is to say, the control section 118 sets the weighting factor W_Size including W_Size_F indicating the band characteristic of the filter, and W_Size_G indicating the gain characteristic of the filter for each corresponding relationship described above.

In this manner, the control section 118 can appropriately control the characteristic of the edge enhancement filter 312 in consideration of the deterioration degree of the resolution of the video signal caused by the conversion of the image-frame size by the image-frame-size conversion section 308 using the weighting factor W_Size.

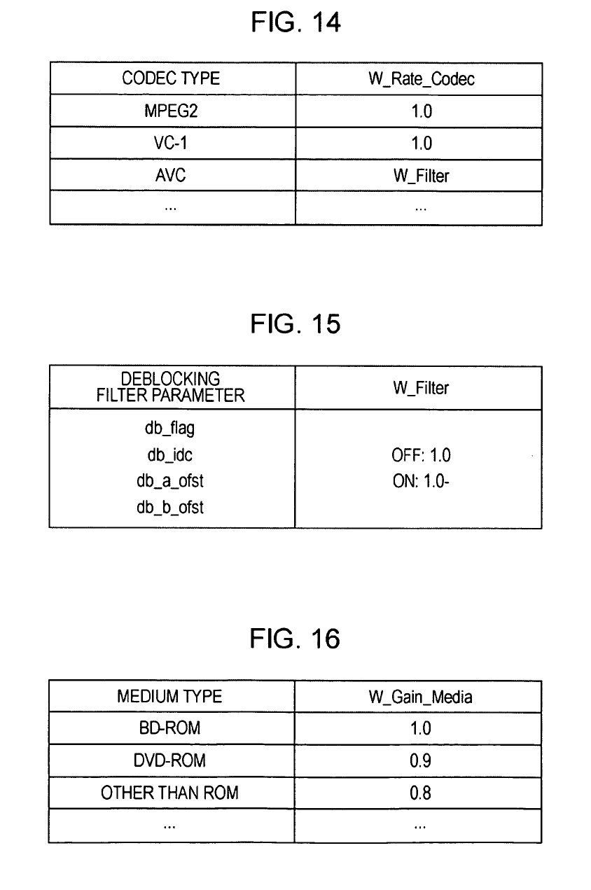

Also, as shown in FIG. 14, the control section 118 sets a control parameter W_Gain_Codec indicating the strength of the edge enhancement by the edge enhancement filter 312 in accordance with the encoding method of the video signal. In particular, for the video signal, like AVC, whose encoding information includes deblocking filter parameter indicating the strength of the deblocking filter processing eliminating the distortion of the boundary areas of adjacent pixel blocks in a picture, the control section 118 may dynamically change the control parameter in accordance with the deblocking filter parameter as shown in FIG. 14.

Specifically, for example, as AVC, when encoding information of the video signal to be processed is included, the control section 118 obtains the following parameters from the stream processor 112 and the decoders 113 and 114 performing decode processing.

That is to say, the control section 118 obtains deblocking_filter_control_present_flag (in the following, called db_flag) included in the picture parameter set of the video signal, disable_deblocking_filer_idc (in the following, called db_idc), slice_alpha_c0_offset_div2 (in the following, called db_a_ofst), and slice_beta_offset_div2 (in the following, called db_b_ofst), which are included in the slice header.

The control section 118 obtains information on whether there is deblocking filter processing and information on the strength of the filter processing. As shown in FIG. 15, the control section 118 sets the value of W_Filter to a reference value, 1 when db_idc=1, that is to say, the deblocking filter processing is OFF, and sets the value of W_Filter to 1 or greater in accordance with the value of db_a_ofst and db_b_ofst when the deblocking filter processing is ON.

By setting in this manner, the control section 118 increases the value of W_Filter on the basis of the characteristic of strengthening the deblocking filter in accordance with the values of db_a_ofst and db_b_ofst, and thereby increases the strength of the edge enhancement processing by the edge enhancement filter 312.

The control section 118 determines Gain, which is a parameter indicating the gain characteristic of the edge enhancement filter 312 by the following expression (9) from the control parameters W_Gain_BR, W_Size_G, and W_Gain_Codec (Filter) obtained as described above.

[Expression 9]

Gain=W_Gain_{—}BR×W_Size_{—}G×W_Gain_Codec (9)

Also, the control section 118 may set a weighting factor W_Gain_Media as shown in FIG. 16 in accordance with the type of medium of the input video signal, and correct the Gain calculated by the expression (9).

Specifically, the control section 118 sets the value of the control parameter, related to a medium other than a ROM, W_Gain_Media low for the storage medium, such as a BD-ROM, a DVD-ROM, etc. The control section 118 controls the strength of the edge enhancement processing by the edge enhancement filter 312 in accordance with, for example the product of Gain and W_Gain_Media. The reason why the control section 118 performs such processing is that the video signal of the medium stored on BD-ROM, DVD-ROM, etc., has little noise compared the video signal of a medium other than a ROM, and thus the image quality is not deteriorated even if the strength of the edge enhancement of the edge enhancement filter 312 is increased.

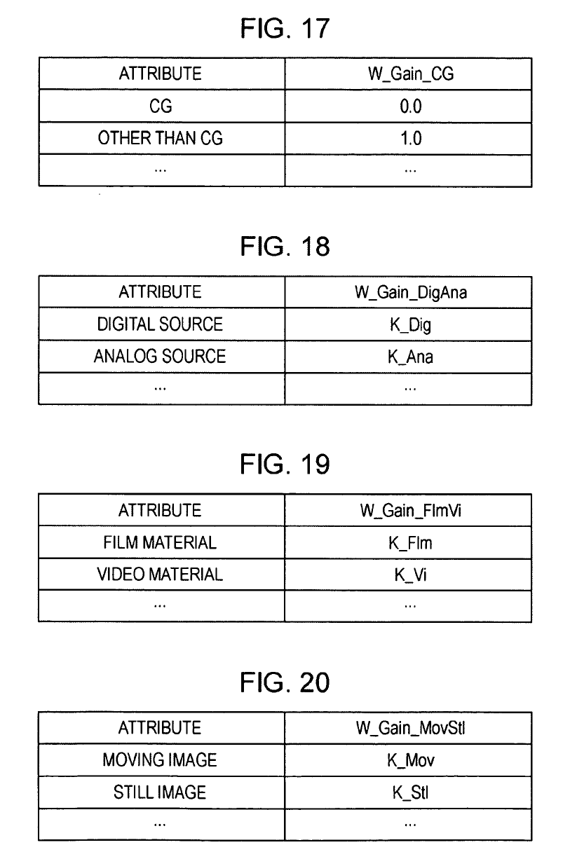

Also, the control section 118 may set a weighting factor W_Gain_CG as shown in FIG. 17 depending on whether the video signal is of computer graphics, and may correct Gain calculated by the expression (9). Specifically, if the video signal is of computer graphics, the control section 118 sets the value of W_Gain_CG to 0, and if the video signal is not of computer graphics, the control section 118 sets the value of W_Gain_CG to 1. The control section 118 controls the strength of the edge enhancement by the edge enhancement filter 312, for example in accordance with the product of Gain and W_Gain_CG. The reason why the control section 118 performs such processing is that when the video signal is of computer graphics, the video signal has originally higher image quality than other video signals, and thus it is not necessary to perform edge enhancement processing.

Also, the control section 118 may set a weighting factor W_Gain_DigAna as shown in FIG. 18 depending on whether the video signal is a digital source or an analog source. That is to say, when the video signal is a digital source, the control section 118 sets W_Gain_DigAna to K_Dig, whereas when the video signal is an analog source, the control section 118 sets W_Gain_DigAna to K_Ana. Specifically, the video signal of an analog source relatively has a larger random noise components compared with the video signal of a digital source, and has a more deteriorated frequency characteristic. Thus, the control section 118 sets K_Ana such that the noise is not enhanced and the video signal is suited to a narrow frequency band compared with K_Dig.

Also, the control section 118 may set a weighting factor W_Gain_FlmVi as shown in FIG. 19 depending on whether the video signal is of film material or video material, and may correct the Gain calculated by the expression (9). That is to say, when the video signal is of a film material, the control section 118 sets W_Gain_FlmVi to K_Flm, whereas when the video signal is of video material, the control section 118 sets W_Gain_FlmVi to K_Vi. Specifically, a film material generally includes more film grain noise than a video source, and thus a picture is taken by intentionally being blurred compared with a video source. Accordingly, the control section 118 sets K_Flm to correct Gain in order to suppress the strength of the edge enhancement compared with K_Vi.

Also, the control section 118 may set a weighting factor W_Gain_MovStl as shown in FIG. 20 depending on whether the video signal is of still image source or moving image source, and may correct the Gain calculated by the expression (9). That is to say, when the video signal is of moving source, the control section 118 sets W_Gain_MovStl to K_Mov, whereas when the video signal is of still image source, the control section 118 sets W_Gain_MovStl to K_Stl. Specifically, a still image source does not have noise changing in the time axis direction, and is higher resolution compared with a moving image source. Accordingly, the control section 118 sets the value of K_Stl to correct Gain in order to perform processing suitable for a broad band compared with K_Mov.

Next, a description will be given of noise reduction processing. The noise reduction filter 311 performs, on the baseband video signal supplied from the other processing sections, for example, block-noise reduction processing, frame-noise reduction processing, and mosquito-noise reduction processing as follows.

The noise reduction filter 311 corrects the distortion of the block boundaries of a video signal in accordance with the encoding difficulty information calculated by the control section 118. Here, the control section 118 calculates the encoding difficulty information from the inverse orthogonal transformation coefficient and the motion vector, which are used for decoding processing by the decoders 113 and 114. Next, the control section 118 corrects the encoding difficulty information in accordance with the average bit rate calculated by the expression (1) or the expression (2). Specifically, when the calculated average bit rate is low, the control section 118 predicts that block noise occurring on a video signal becomes relatively large, and thus the control section 118 performs correction for increasing the value of the encoding difficulty information, and supplies the encoding difficulty information after the correction to the noise reduction filter 311. At this time, the noise reduction filter 311 sets the correction strength of block distortion higher compared with the uncorrected information in accordance with the encoding difficulty information, and performs filter processing on the video signal.

Also, the noise reduction filter 311 performs processing eliminating noise components calculated by the control section 118 as frame noise. Here, the control section 118 calculates a frame difference signal from, for example, consecutive frames in time, and detects noise components included in each frequency of the calculated frame difference signal. Next, the control section 118 corrects the detected noise components in accordance with the average bit rate calculated by the expression (1) or the expression (2). In particular, it is difficult to detect, with high precision, the noise level of low-frequency components generated by compression or expansion processing. Accordingly, when the calculated average bit rate is low, the control section 118 predicts that the noise level of generated low-frequency components becomes relatively large, thus the control section 118 performs correction for increasing mainly the level of low-frequency components among the detected noise levels, and supplies the signal to the reduction filter 311. The noise reduction filter 311 performs processing eliminating the corrected noise components as frame noise.

Furthermore, the noise reduction filter 311 obtains, for example, the dynamic range DR of a small block of the video signal in order to reduce the mosquito noise included in the video signal. The noise reduction filter 311 compares the obtained dynamic range DR and a threshold value Th calculated by the control section 118. If DR is greater than Th, the noise reduction filter 311 determines that mosquito noise is included, and performs the processing for reducing the mosquito noise. In order to obtain the dynamic range DR of a small block of the video signal, the noise reduction filter 311 obtains a maximum value and a minimum value of the values of the pixels in the block, and calculates the dynamic range DR by subtracting the minimum value from the maximum value. At the same time, from the quantization information obtained at the time of decoding the video signal, the control section 118 sets the threshold value Th to high when the quantization step is large, whereas the control section 113 sets the threshold value Th to low when the quantization step is small. Also, when the quantization step is small, and the average bit rate calculated by the expression (1) or the expression (2) is high, the control section 118 controls the noise reduction filter 311 such that the strength of the filter processing performed on mosquito noise is set low. When the quantization step is large, and the average bit rate is low, the control section 118 controls the noise reduction filter 311 such that the strength of the filter processing performed on mosquito noise is set high.

Also, when the control section 118 calculates the average bit rate by the expression (2), it is desirable to use the amount of sum bits generated at intervals of about 0.5 to 1 second. This is shorter than 1 second, which is the time period used for the control index related to the edge enhancement filter 312. This is because even if the characteristics of the noise reduction filter are changed frequently, the image quality of the video signal is not relatively deteriorated compared with the edge enhancement processing.

In this manner, the control section 118 calculates the average bit rate from the video signal, and controls the setting of the strength of the noise reduction processing related to the noise reduction filter 311 in accordance with the calculated average bit rate. It is therefore possible to perform suitable filter processing in accordance with the attribute of the video signal, and to output a high-image-quality video signal whose individual noise components are effectively reduced.

In this regard, the control section 118 is not limited to control the strength of the filter processing related to the noise reduction filter 311 simply in accordance with the average bit rate. The control section 118 may control the characteristic of the noise reduction filter 311 using the average bit rate weighted in accordance with another attribute of the video signal as a control index.

As described above, the control section 118 changes the settings of the strength related to the edge enhancement processing and the noise reduction processing which reduces block noise, frame noise, mosquito noise, etc., that are included in the video signal in accordance with the attribute of the source of the video signal. Thus, the control section 118 can appropriately control the characteristic of the edge enhancement filter 312 and the noise reduction filter 311. Thereby, it is possible to improve the image quality of the output video signal.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
input means for inputting a video signal;
decoding means for decoding the video signal input by the input means;
filtering means for performing predetermined filter processing on the video signal decoded by the decoding means; and
control means for calculating an average bit rate by dividing an amount of bits generated per predetermined data unit from the video signal decoded by the decoding means, and controlling a characteristic of filter processing performed by the filtering means in accordance with the average bit rate,
wherein when the video signal input by the input means is input per image file, the control means calculates the average bit rate by dividing a file size of the image file by a playback time corresponding to the file size, and when the video signal input by the input means is sequentially input per picture, the control means calculates the average bit rate by dividing a sum of generated bits per picture for a predetermined number of frames by the predetermined number of frames and the frame rate.

2. The image processing apparatus according to claim 1,
wherein the control means controls the characteristic of the filter processing performed by the filtering means in accordance with the average bit rate weighted in accordance with an image-frame size of the video signal input by the input means.

3. The image processing apparatus according to claim 1, further comprising image-frame-size conversion means for converting an image-frame size of the video signal input by the input means,
wherein the control means controls the characteristic of the filter processing performed by the filtering means in accordance with the average bit rate weighted in accordance with a corresponding relationship between an image-frame size of a video signal into which the video signal is converted by the image-frame-size conversion means and an image-frame size of the video signal before the conversion.

4. The image processing apparatus according to claim 1,
wherein the decoding means decodes the video signal on the basis of an encoding method of the video signal input by the input means, and
the control means controls the characteristic of the filter processing performed by the filtering means in accordance with the average bit rate weighted in accordance with a compression rate of the encoding method of the video signal input by the input means.

5. The image processing apparatus according to claim 1,
wherein the input means inputs the video signal including a picture encoded for each pixel block and a deblocking filter parameter indicating a strength of deblocking filter processing eliminating distortions on a boundary area of adjacent pixel blocks in the picture,
the decoding means decodes the video signal having been subjected to deblocking filter processing in accordance with the deblocking parameter in the video signal from the video signal input by the input means, and
the control means controls the characteristic of the filter processing performed by the filtering means in accordance with the average bit rate weighted in accordance with the deblocking filter parameter included in the video signal input by the input means.

6. The image processing apparatus according to claim 1,
wherein the input means inputs the video signal stored on a storage medium, and
the control means controls the characteristic of the filter processing performed by the filtering means in accordance with the average bit rate and a type of the storage medium.

7. The image processing apparatus according to claim 1,
wherein the control means controls the characteristic of the filter processing performed by the filtering means in accordance with the average bit rate and a determination result on whether the video signal input by the input means is a computer graphic or not.

8. The image processing apparatus according to claim 1,
wherein the control means controls the characteristic of the filter processing performed by the filtering means in accordance with the average bit rate and a determination result on whether the video signal input by the input means is an analog signal or a digital signal.

9. The image processing apparatus according to claim 1,
wherein the control means controls the characteristic of the filter processing performed by the filtering means in accordance with the average bit rate and a determination result on whether the video signal input by the input means is of film material or not.

10. The image processing apparatus according to claim 1,
wherein the control means controls the characteristic of the filter processing performed by the filtering means in accordance with the average bit rate and a determination result on whether the video signal input by the input means is of a still image or a moving image.

11. A method of performing image processing on a video signal input by predetermined input means, the method comprising the steps of:
decoding the video signal input by the input means;
filtering for performing predetermined filter processing on the video signal decoded by the step of decoding; and
controlling for calculating an average bit rate by dividing an amount of bits generated per predetermined data unit from the video signal decoded by the step of decoding, and controlling a characteristic of the filter processing in accordance with the average bit rate,
wherein, in the step of controlling, when the video signal input by the input means is input per image file, the average bit rate is calculated by dividing a file size of the image file by a playback time corresponding to the file size, and when the video signal input by the input means is sequentially input per picture, the control means calculates the average bit rate by dividing a sum of generated bits per picture for a predetermined number of frames by the predetermined number of frames and the frame rate.

12. An image processing apparatus comprising:
an input mechanism for inputting a video signal;
a decoding mechanism for decoding the video signal input by the input mechanism;
a filtering mechanism for performing predetermined filter processing on the video signal decoded by the decoding mechanism; and
a control mechanism for calculating an average bit rate by dividing an amount of bits generated per predetermined data unit from the video signal decoded by the decoding mechanism, and controlling a characteristic of filter processing performed by the filtering mechanism in accordance with the average bit rate,
wherein when the video signal input by the input mechanism is input per image file, the control mechanism calculates the average bit rate by dividing a file size of the image file by a playback time corresponding to the file size, and when the video signal input by the input mechanism is sequentially input per picture, the control mechanism calculates the average bit rate by dividing a sum of generated bits per picture for a predetermined number of frames by the predetermined number of frames and the frame rate.
